(19) United States
(12) Patent Application Publication
(10) Pub. No.: US 2026/0059367 A1
(43) Pub. Date: Feb. 26, 2026

(54) SUPPORT EFFICIENT ENERGY TRANSFER

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Wanshi CHEN, San Diego, CA (US); Yuchul KIM, San Diego, CA (US); Zhikun WU, Beijing (CN); Linhai HE, San Diego, CA (US); Huilin XU, Temecula, CA (US); Peter GAAL, San Diego, CA (US)

(21) Appl. No.: 19/103,200

(22) PCT Filed: Sep. 23, 2022
(86) PCT No.: PCT/CN2022/120793

§ 371 Date: Feb. 11, 2025

(51) Int. Cl. H04W 24/10; H04W 72/25; H04W 72/54; H04W 72/56

(52) U.S. Cl. CPC H04W 24/10; H04W 72/25; H04W 72/54; H04W 72/56

(57) ABSTRACT

Apparatus, methods, and computer program products for supporting energy harvesting (EH) wireless devices are provided. An example method may include receiving energy harvesting information associated with at least one second network entity. The example method may further include transmitting, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication.

### TECHNICAL FIELD

The present disclosure relates generally to communication systems, and more particularly, to wireless communication systems with energy transfer between devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity (e.g., such as a user equipment (UE) or a base station) are provided. The apparatus may include a memory and at least one processor coupled to the memory. The at least one processor may be configured to receive energy harvesting information associated with at least one second network entity. The at least one processor may be configured to transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication.

In another aspect of the disclosure, a method, a computer-readable medium, and an apparatus at a first network entity (e.g., such as a UE or a base station) are provided. The apparatus may include a memory and at least one processor coupled to the memory. The at least one processor may be configured to receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. The at least one processor may be configured to apply the first set of preferred resources for the energy harvesting or refrain from applying the first set of non-preferred resources for the energy harvesting.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates example aspects of sidelink communication between devices.

FIG. 5 illustrates examples of resource reservation for sidelink communication.

FIG. 6 is a diagram illustrating a timing diagram for a UE employing a sensing mechanism.

FIGS. 7A and 7B are diagrams illustrating inter UE coordination between UEs.

FIG. 8 is a diagram illustrating example backscatter communication.

FIG. 9 is a diagram illustrating example backscatter communication with interrogator (reader)-Talks-First (ITF) procedure between reader and tag.

FIG. 10 is a diagram illustrating example communications between wireless devices.

FIG. 11 is a diagram illustrating example thresholds.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

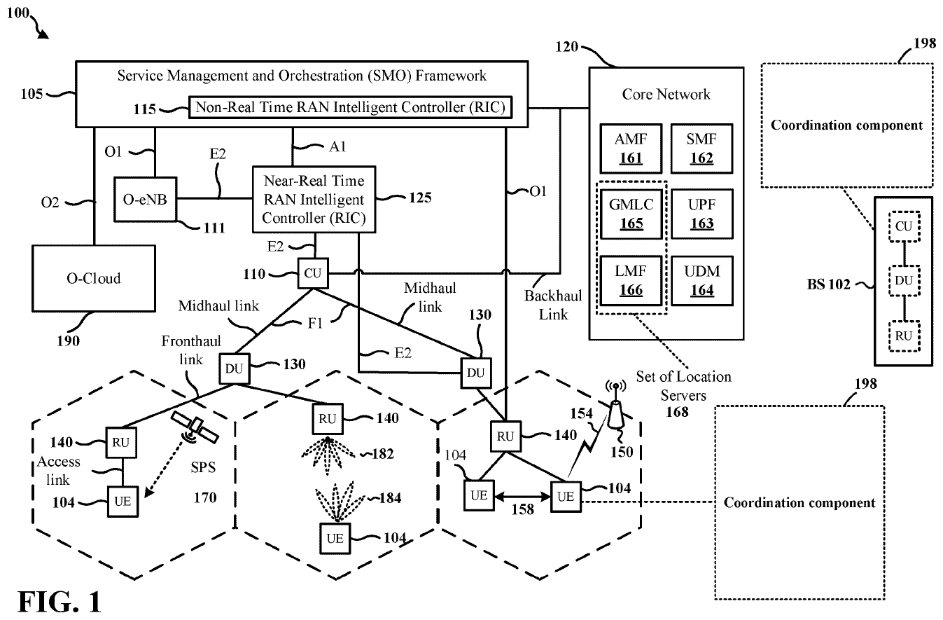

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RTRICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include a coordination component 198. In some aspects, the coordination component 198 may be configured to receive energy harvesting information associated with at least one second network entity. In some aspects, the coordination component 198 may be further configured to transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, the coordination component 198 may be configured to receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, the coordination component 198 may be further configured to apply the first set of preferred resources for the energy harvesting or refrain from applying the first set of non-preferred resources for the energy harvesting.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

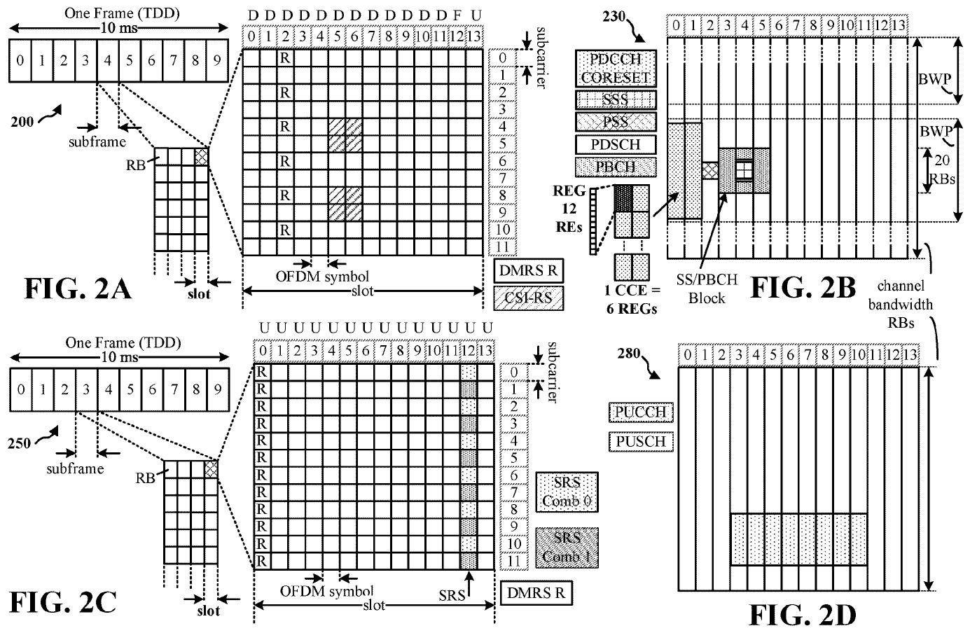

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

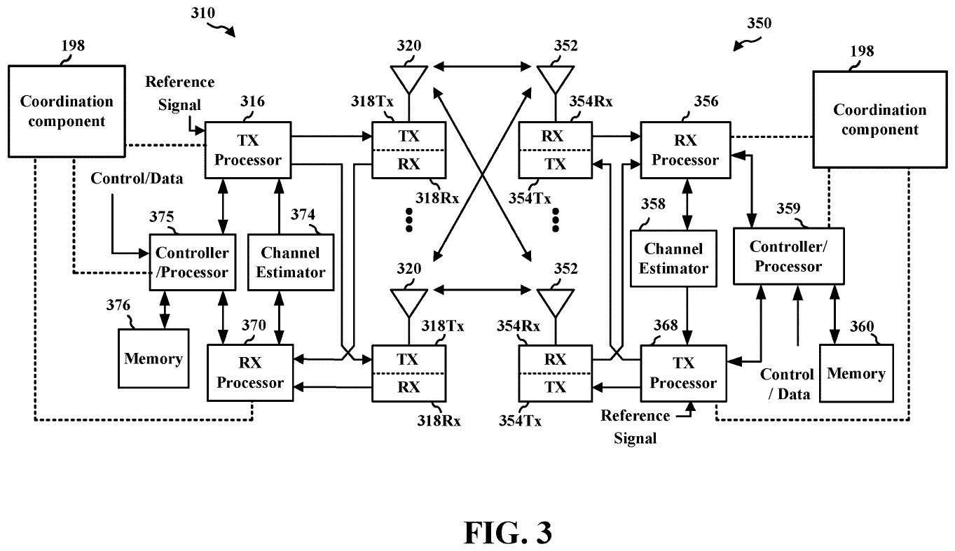

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with coordination component 198 of FIG. 1.

At least one of the TX processor 316, the RX processor 370, and the controller/processor 375 may be configured to perform aspects in connection with coordination component 198 of FIG. 1.

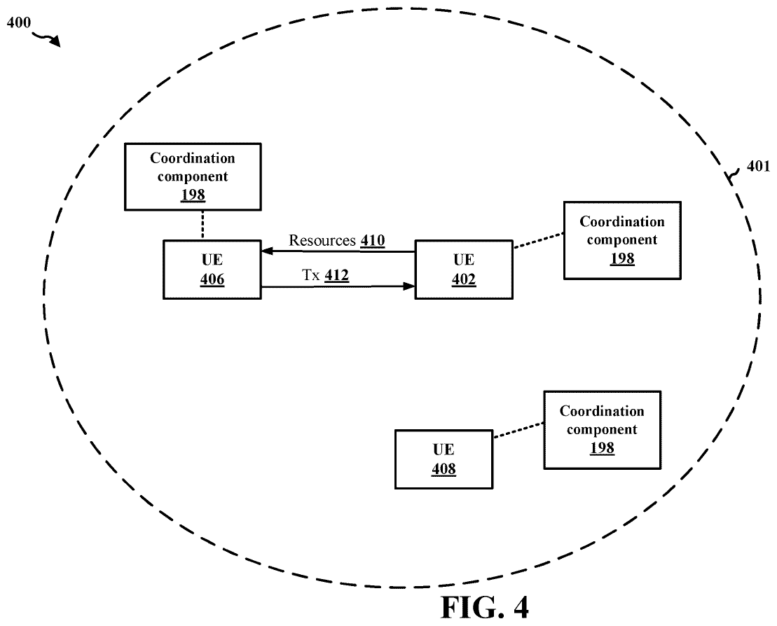

FIG. 4 illustrates an example 400 of sidelink communication between devices, as presented herein. The communication may be based on a sidelink structure. For example, a first UE 402 may transmit a sidelink transmission 410, e.g., including a control channel (e.g., PSCCH) and/or a corresponding data channel (e.g., PSSCH), that may be received by a second UE 406 and/or a third UE 408. The sidelink transmission 410 may be received directly from the first UE 402, e.g., without being transmitting through a base station.

The first UE 402, the second UE 406, and/or the third UE 408 may each be capable of operating as a transmitting device in addition to operating as a receiving device. Thus, the second UE 406 is illustrated as transmitting a sidelink transmission 412 that is received by the first UE 402. One or more of the sidelink transmissions 410, 412 may be broadcast or multicast to nearby devices. For example, the first UE 402 may transmit communications intended for receipt by other UEs within a range 401 of the first UE 402. In other examples, one or more of the sidelink transmissions 410, 412 may be groupcast to nearby devices that are a member of a group. In other examples, one or more of the sidelink transmissions 410, 412 may be unicast from one UE to another UE.

A sidelink transmission may provide sidelink control information (SCI) including information to facilitate decoding the corresponding data channel. For example, a transmitting device (sometimes referred to as an “originating device,” a “transmitting UE,” or an “originating UE”) may transmit SCI including information that a receiving device (sometimes referred to as a “target device,” a “receiving UE,” or a “target UE”) may use to avoid interference. For example, the SCI may indicate reserved time resources and/or reserved frequency resources that will be occupied by the data transmission, and may be indicated in a control message from the transmitting device. The number of TTIs, as well as the RBs that will be occupied by the data transmission, may be indicated in a control message from the first UE 402. In some examples, the SCI may be used by a receiving device to avoid interference by refraining from transmitting on the occupied resources during a data transmission.

One or more of the first UE 402, the second UE 406, and/or the third UE 408 may include a coordination component, similar to the coordination component 198 described in connection with FIG. 1.

Sidelink communication enables a first UE to communicate with another UE directly. For example, the first UE and the other UE may communicate without routing the communication through a base station. Sidelink may be beneficial for vehicle-based communications (e.g., V2V, V2I, V2N, V2P, C-V2X, etc.) that allows a vehicle UE to communicate directly with another UE or a pedestrian UE. When dealing with V2X communication, power consumption by the vehicle UE might not be a concern.

However, it may be beneficial to implement power saving modes for some devices. Two examples of power saving modes include partial sensing or random selection and discontinuous reception (DRX). In either DRX or partial sensing, the UE may skip sensing for resource reservations for portions of time. The skipped sensing may save battery power at the UE, for example.

Sidelink communication may be based on different types or modes of resource allocation mechanisms. In a first resource allocation mode (which may be referred to herein as “Mode 1”), centralized resource allocation may be provided by a network entity. For example, and referring to the example of FIG. 1, a base station 102/180 may determine resources for sidelink communication and may allocate resources to different UEs to use for sidelink transmissions. In this first mode, a UE receives the allocation of sidelink resources from the base station 102/180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots.

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation Mode 2, the UE may determine (e.g., sense) whether a selected sidelink resource has been reserved by other UE(s) before selecting the sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

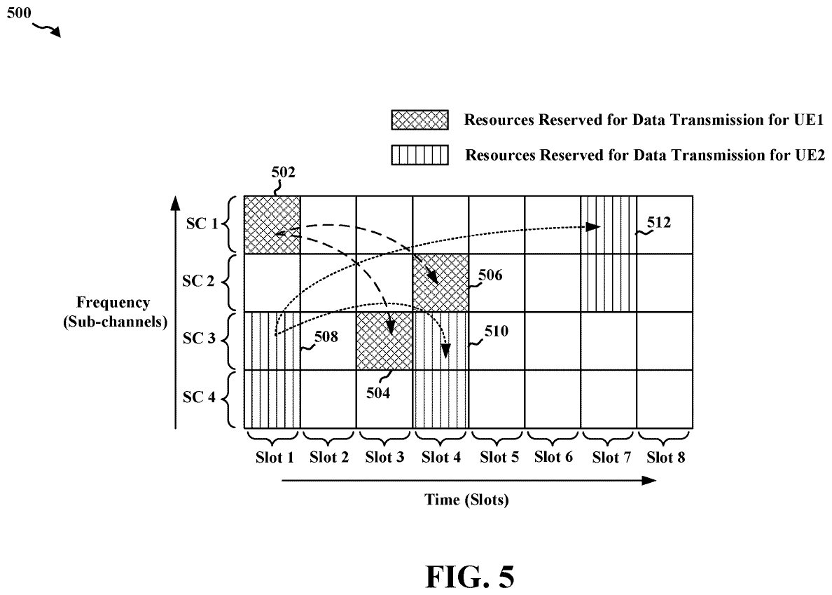

FIG. 5 is an example 500 of time and frequency resources showing reservations for sidelink transmissions, as presented herein. The resources may be included in a sidelink resource pool, for example. The resource allocation for each UE may be in units of one or more sub-channels in the frequency domain (e.g., sub-channels SC1 to SC 4), and may be based on one slot in the time domain (e.g., slots “1” to 8). The UE may also use resources in the current slot to perform an initial transmission, and may reserve resources in future slots for retransmissions. In the illustrated example of FIG. 5, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., a first data retransmission 504 and a second data retransmission 506). For example, the first UE may reserve sub-channels SC 3 at slot 3 and SC 2 at slot 4 for future retransmissions as shown by FIG. 5. The first UE then transmits information regarding which resources are being used and/or reserved by it to other UE(s). The first UE may do so by including the reservation information in a reservation resource field of the SCI, e.g., a first stage SCI (SCI 1). There may be a second stage SCI (SCI 2). As one example, the SCI 2 may be mapped to contiguous RBs in a PSSCH starting from the first symbol associated with PSSCH DM-RS. A format of the SCI 2 may be indicated in the first stage SCI. The SCI 1 may be transmitted in a PSCCH. A number of resource elements (REs) may be derived based on the SCI 1. A starting location of the SCI 2 may be defined and known to a UE. In some aspects, a UE may not blindly decode SCI 2. An SCI 2 format may include one or more of a HARQ process identifier (ID), a new data indicator (NDI), a source ID, a destination ID, a CSI report trigger, or the like. An SCI 2 format associated with a groupcast may also include a zone ID indicating a location of a transmitter and a communication range for sending feedback.

FIG. 5 illustrates that a second UE (“UE2”) reserves resources in sub-channels SC 3 and SC 4 at slot “1” for a current data transmission 508, reserves a first data retransmission 510 at slot 4 using sub-channels SC 3 and SC 4, and reserves a second data retransmission 512 at slot 7 using sub-channels SC “1” and SC 2, as shown by FIG. 5. Similarly, the second UE may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or only for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, the UE may determine a set of candidate resources (e.g., by monitoring SCI from other UEs and removing resources from the set of candidate resources that are reserved by other UEs in a signal for which the UE measures an RSRP above a threshold value). The UE may also select N resources for transmissions and/or retransmissions of a TB. As an example, the UE may randomly select the N resources from the set of candidate resources previously determined. For each transmission, the UE may reserve future time and frequency resources for an initial transmission and up to two retransmissions. The UE may reserve the resources by transmitting SCI indicating the resource reservation. For example, in the example in FIG. 5, the second UE may transmit SCI reserving resources for the current data transmission 508, the first data retransmission 510, and the second data retransmission 512.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

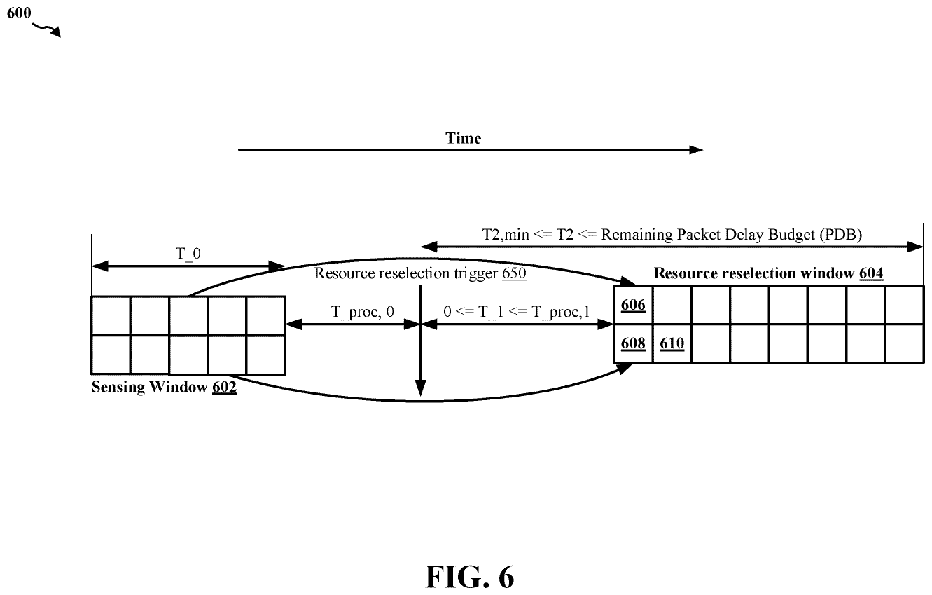

In the resource allocation Mode 2, a higher layer may request the UE 104 that includes the coordination component 198 to determine a subset of resources from which the higher layer may select resources for PSSCH/PSCCH transmissions. FIG. 6 illustrates an example timing diagram 600 for a UE that may be triggered to select a resource for sidelink transmission in response to a resource selection trigger 650. The timing diagram shows a timing for sensing for resource reservations from other UEs, such as the resource reservations described in connection with FIG. 5. As an example, the resource selection trigger 650 may include having data for transmission. Although FIG. 6 is described in connection with a UE, the resource selection may also be applied by other sidelink devices. In response to the resource selection trigger 650, the UE may consider signals received within a sensing window 602 of duration T_0 and determine information (e.g., SCI with resource reservations) received within the sensing window 602. For example, the UE may determine which resources were used by other UE(s) or reserved by other UE(s) during the sensing window 602. The UE may anticipate that the previously used resources may also be used by the other UE in the future. A signal received in the sensing window may include SCI indicating a resource reservation for a resource within the resource selection window 604 following the resource selection trigger 650. Based on the past use of resources and/or the reservation of resources (e.g., the “sensing” of resources), the UE may determine which resources are scheduled for use and/or determine which resources are not scheduled for use. For example, based on the sensing of the resources during the sensing window 602, the UE may determine that a first resource 606 and a second resource 608 may be reserved during the slot associated with the resource selection trigger 650 and/or during a future slot. The UE may exclude candidate resources that are reserved by other UEs from a candidate set of resources when selecting a sidelink transmission resource. In some examples, the UE may exclude candidate resources that are reserved by another UE and that meet one or more conditions, such as the reservation signal meeting an RSRP threshold. The UE may select resource 610 for a transmission.

In some wireless communication systems, a receiving UE may perform sensing, then inform the transmitting UE (along with other UEs) about the resources that are available for transmission based on the sensing result. For example, the receiving UE may be a smartphone with a higher processing power and higher battery capacity than the transmitting UE, which may be a smartwatch with limited battery capacity and limited processing power. Therefore, it may be more efficient to have the higher processing power with higher battery capacity receiving UE to perform the sensing for the transmitting UE.

In some instances, multiple UEs may transmit at the same time and may not receive the overlapping communication (e.g., SCI indicating resource reservations) from each other and/or from a base station. Such a UE may miss or be unaware of transmissions and sidelink reservations by other UEs. Therefore, two UEs may reserve the same resource block for a future sidelink transmission, which may result in a resource collision. A resource collision occurs for sidelink transmissions that overlap at least partially in time, and which may overlap, at least partially, in frequency.

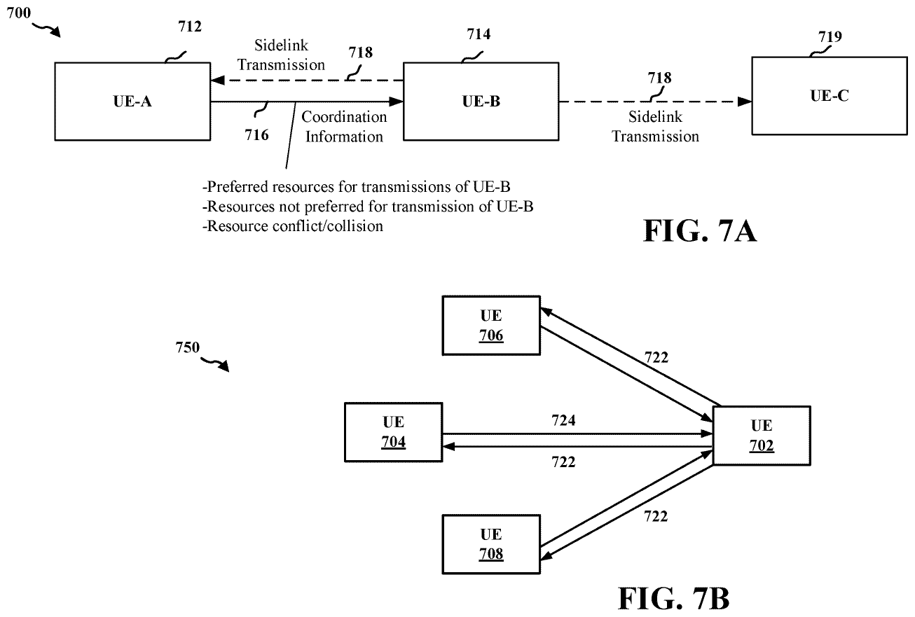

To reduce or avoid resource collisions under such instances, and to improve sidelink communication among UEs, the UEs may coordinate among themselves by generating and sharing inter-UE coordination information with other UEs. FIG. 7A is a diagram 700 illustrating the exchange of inter-UE coordination information, where a first UE (“UE-A”) 712 transmits inter-UE coordination information 716 to a second UE (“UE-B”) 714. In some aspects, the transmission of inter-UE coordination information may include resource reservation forwarding by the UE-A.

The inter-UE coordination information 716 may include information based on the UE's sensing information (e.g., resource reservations of other UEs that are sensed by UE 712 (e.g., UE-A)), inter-UE coordination information from another UE, resources that are bad, undesirable, or non-preferred for the UE-A 712 (e.g., resources subject to high interference), resources which are preferred or better than other resources for the UE-A 712, etc.

The inter-UE coordination information 716 may indicate candidate resources for sidelink transmission or preferred resources for transmissions by UE-B 714. In some aspects, the information indicative of preferred resources for UE-B's transmission may be referred to as “Type A” inter-UE coordination information. The UE-A 712 may use the inter-UE coordination information 716 to inform the UE-B 714 about which sub-channels and slots may be used for communicating with the UE-A 712 and/or which sub-channels and slots may not be used because they are occupied or reserved by the UE-A 712 and/or other UEs. The UE-A may indicate a set of resources that may be more preferred for UE-B's transmission based on UE-A's evaluation. The candidate resources may indicate a group of resources from which the UE-B 714 (e.g., UE-B) may select for the sidelink transmission 718. As illustrated, the sidelink transmission 718 may be for UE-A 712 or for one or more different UEs, e.g., UE-C 719. In some aspects, the UE-A may be a potential receiver of the UE-B's transmission, and the inter-UE coordination information may enable mode 2 resource allocation that is based on resource availability from a potential receiver's perspective, which may address reception challenges for a hidden node. In some aspects, the inter-UE coordination information 716 may indicate resources for a sidelink transmission, e.g., particular resources on which the UE-B 714 is to transmit the sidelink transmission 718 rather than candidate resources that the UE-B 714 may select.

In some aspects, the inter-UE coordination information 716 may indicate a set of resources that may not be preferred for UE-B's transmission, such as resources that may not be available for UE-B to transmit a sidelink transmission based on the UE-A's evaluation. In some aspects, the information indicative of non-preferred resources for UE-B's transmission may be referred to as “Type B” inter-UE coordination information.

In some aspects, the inter-UE coordination information 716 may indicate a half-duplex conflict. For example, the inter-UE coordination information 716 may indicate a collision in time and/or frequency for two transmitting UEs that are unable to receive the other, respective transmission in a half-duplex mode. In some aspects, the inter-UE coordination information 716 may indicate a collision of resources (e.g., reserved resources) in time and/or frequency. In some aspects, the information indicative of a collision/conflict in resources may be referred to as “Type C” inter-UE coordination information.

Based at least in part on the inter-UE coordination information 716 from the UE-A 712, the UE 704 may make a better decision on which resources to use and/or reserve for its sidelink transmission 718 to avoid resource collisions. The UE-A 712 may share its inter-UE coordination information 716 with multiple UEs, and the UE-B 714 may receive the inter-UE coordination information 716 from multiple UEs. Inter-UE coordination information 716 may be transmitted in any of various ways.

The UE-A 712 may transmit inter-UE coordination information 716 in a PSFCH, e.g., indicative of a resource collision or a half-duplex conflict. The UE-A 712 may transmit inter-UE coordination information 716 in SCI. For example, the UE-A 712 may transmit shared sensing information, candidate resource information for a sidelink transmission, or particular resources for a sidelink transmission in SCI-2 transmitted in PSSCH. For example, a first portion of SCI (e.g., SCI-1) may be transmitted in PSCCH, and a second portion of SCI (e.g., SCI-2) may be transmitted in PSSCH. The UE-A 712 may transmit inter-UE coordination information 716 in a medium access control-control element (MAC-CE), e.g., on the PSSCH. The UE-A 712 may transmit the inter-UE coordination information 716 in a new physical channel (e.g., that is different than PSCCH, PSSCH, PSFCH, etc.). For example, the UE-A 712 may transmit the inter-UE coordination information 716 in a physical channel that is configured for or dedicated to inter-UE configuration information. The UE-A 712 may transmit the inter-UE coordination information 716 in RRC signaling.

In some aspects, the UE-A 712 may transmit the inter-UE coordination information 716 periodically. In some aspects, the UE-A 712 may transmit aperiodic inter-UE coordination information 716 in response to a trigger. Among other examples, the trigger may be based on the occurrence of an event, such as the occurrence of/detection of a resource collision, the occurrence of/detection of a half-duplex conflict, etc. For example, if the UE-A 712 detects a resource collision, the UE-A 712 may respond by transmitting inter-UE coordination information 716.

The UE-B 714 may utilize the inter-UE coordination information 716 in various ways. If the inter-UE coordination information 716 includes information about resources that are preferred for transmissions of the UE-B 714 and/or resources that are not preferred for transmissions of the UE-B 714, the UE 704 may select resource(s) to be used for its sidelink transmission resource selection, or resource re-selection, may be based on both UE-B's sensing result (if available) and the received inter-UE coordination information 716 according to a first option. In a second option, the UE-B 714 may select resource(s) to be used for its sidelink transmission resource selection, or resource re-selection, may be based on the received inter-UE coordination information 716 and not based on sensing. In a third option, the UE-B 714 may select resource(s) to be used for its sidelink transmission resource selection, or resource re-selection, may be based on the received inter-UE coordination information 716 (which may allow the UE-B to use or not use sensing in combination with the inter-UE coordination information 716).

FIG. 7B is a diagram 750 illustrating the exchange of inter UE coordination information that a UE 702 may provide to multiple UEs. As illustrated in FIG. 7B, the UE 702 may be more capable of performing sensing in comparison with the UE 704, the UE 706, or the UE 708. For example, the UE 702, which may be a receiving UE that receives a transmission from the UE 704, the UE 706, or the UE 708) may have a higher processing power and/or higher battery capacity than the UE 704, the UE 706, or the UE 708. Therefore, it may be more efficient for the higher battery capacity/processing power UE 702 to perform sensing and transmit (e.g., groupcast) resource availability information 722 to the UE 704, the UE 706, and the UE 708. Moreover, the UE 702 may have information about the UE 704, the UE 706, and the UE 708 based on measuring RSRP of signals on incoming links. For example, the UE 702 may be able to measure RSRP on a link between the UE 702 and the UE 704, a link between the UE 702 and the UE 706, and a link between the UE 702 and the UE 708. By measuring the different links, the UE 702 may be able to better identify resources that are available.

In some circumstances, based on the sensing, the receiving UE 702 may identify a first set of available resources that may be smaller than a threshold amount of resources (e.g., determined to be unsuitably small by comparing a size of the available resources with an availability threshold) for the transmission 724 from the UE 704 to the UE 702.

In addition to higher capability devices, wireless communication may support reduced capability (RedCap) devices. Among others, examples of higher capability devices include premium smartphones, V2X devices, URLLC devices, eMBB devices, etc. Among other examples, reduced capability devices may include wearables (e.g., such as smart watches, augmented reality glasses, virtual reality glasses, health and medical monitoring devices, etc.), industrial wireless sensor networks (IWSN) (e.g., such as pressure sensors, humidity sensors, motion sensors, thermal sensors, accelerometers, actuators, etc.), surveillance cameras, low-end smartphones, etc. For example, NR communication systems may support both higher capability devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In addition to reduced capability devices, devices with a lower capability than reduced capability devices including lower power consumption and a less complicated structure may be included in wireless communication systems. In some wireless communication systems, passive wireless devices such as zero-power passive IoT wireless devices may be included. Such passive wireless devices may be without active RF components and may perform transmissions based on backscatter communication and may perform reception based on envelope detection or an envelope detector. Backscatter communication may modulate information on an incoming RF signal (which may be a carrier wave that may carry communication between other devices) by an adaptation of antenna load impedance. A passive wireless device may be battery-less or battery assisted. For example, a passive wireless device may operate based on energy harvesting from an incoming radio wave with or without a battery as an additional power source. A passive wireless device may have low power consumption, such as between 1 microwatt to 1000 microwatts. Such passive wireless devices may be devices for inventory management, wireless sensors, or the like. Passive devices may use backscatter communication to communicate with another network entity, such as a base station.

Backscatter communication may enable radio frequency identification (RFID). For example, a reader may send a continuous waveform signal and interrogate commands. An RF tag (which is a passive wireless device) may harvest energy from the continuous waveform signal and may respond to the interrogation by varying its input impedance (e.g., between conjugate match and strongly mismatched), therefore modulating the backscattered signals. RFID is a rapidly growing technology impacting many industries due to its potential for inventory/asset management inside and outside warehouse, IoT, sustainable sensor networks in factories and/or agriculture, and smart home. RFID may include small transponders, which may be referred to as tags, emitting an information-bearing signal upon receiving a signal. RFID may be operated without battery at low operational expenditures (OPEX) and may use small amount of resources. RFID may have use lower amount of maintenance and may have a long life-cycle.

In some aspects, the term “resources” may refer to time and frequency resources that a wireless device may monitor. In some aspects, the term “preferred resources” may be used interchangeably with “suitable resources” and the term “unpreferred resources” may be used interchangeably with “unsuitable resources”. In some aspects, preferred resources or non-preferred resources may be any resources that a wireless device is aware of (e.g., based on coordination messages, resources assigned to the wireless device, or the like). The wireless device may determine some resources as preferred or non-preferred for data communication and determine some resources as preferred or non-preferred for energy harvesting. As used herein, the term “preferred resources for data communication” may refer to time and frequency resources that may be indicated by a network entity (such as a UE or a gNB) to a second network entity to use for a data transmission. The term “non-preferred resources for data communication” may refer to time and frequency resources that may be indicated by a network entity (such as a UE or a gNB) to a second network entity to avoid for a data transmission. In some aspects, the non-preferred resources may nonetheless be used by the second network entity for the data transmission despite being non-preferred (which may cause worse performance). The term “preferred resources for energy transfer” may refer to time and frequency resources that may be indicated by a network entity (such as a UE or a gNB) to a second network entity to use for energy transfer or energy harvesting. The term “non-preferred resources for energy transfer” may refer to time and frequency resources that may be indicated by a network entity (such as a UE or a gNB) to a second network entity to avoid for an energy transfer or energy harvesting. In some aspects, the non-preferred resources may be used by the second network entity for the energy transfer despite being non-preferred (which may cause worse performance). In some aspects, preferred may be based on resources being available for use and non-preferred may be based on being unavailable for use. In some aspects, preferred or non-preferred resources may be both available for use. As used herein, the term “energy transfer” transfer may be used interchangeably with “energy harvesting” to refer to a procedure in which a wireless device (which may be referred to as an “energy harvesting wireless device”) uses a carrier wave transmitted by another wireless device (which may be referred to as a “power provider wireless device” to get energy). In some aspects, preferred resources for data communication may be preferred for energy transfer or non-preferred for energy transfer. In some aspects, non-preferred resources for data communication may be preferred for energy transfer or non-preferred for energy transfer. In some aspects, preferred resources for energy transfer may be preferred for data communication or non-preferred for data communication. In some aspects, non-preferred resources for energy transfer may be preferred for data communication or non-preferred for data communication. An example of an energy harvesting (EH) device may be a RF tag and an example of a power provider (PP) wireless device may be a RF interrogator (which may also be referred to as “RF reader”).

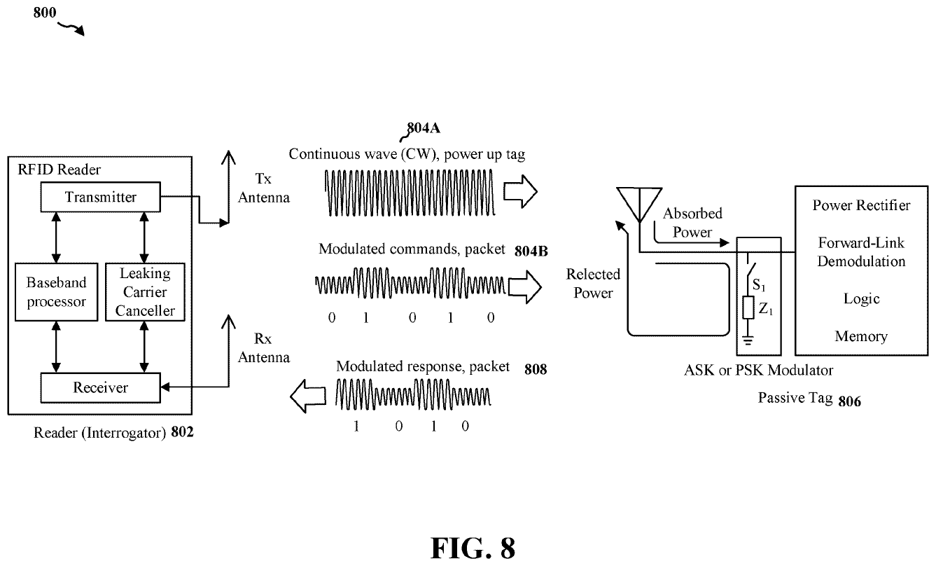

FIG. 8 is a diagram 800 illustrating example backscatter communication. As illustrated in FIG. 8, a RF reader 802 may transmit a continuous wave (CW) 804A for powering up a RF tag 806. Based on the continuous wave 804A, the RF tag 806 may be powered on. The RF reader 802 may also transmit a wave carrying modulated commands 804B to the RF tag 806 (e.g., by modulating the CW). Based on the energy gathered from the wave carrying the modulated commands 804B, the RF tag may transmit (e.g., by modulating and reflecting) modulated response 808 to the RF reader.

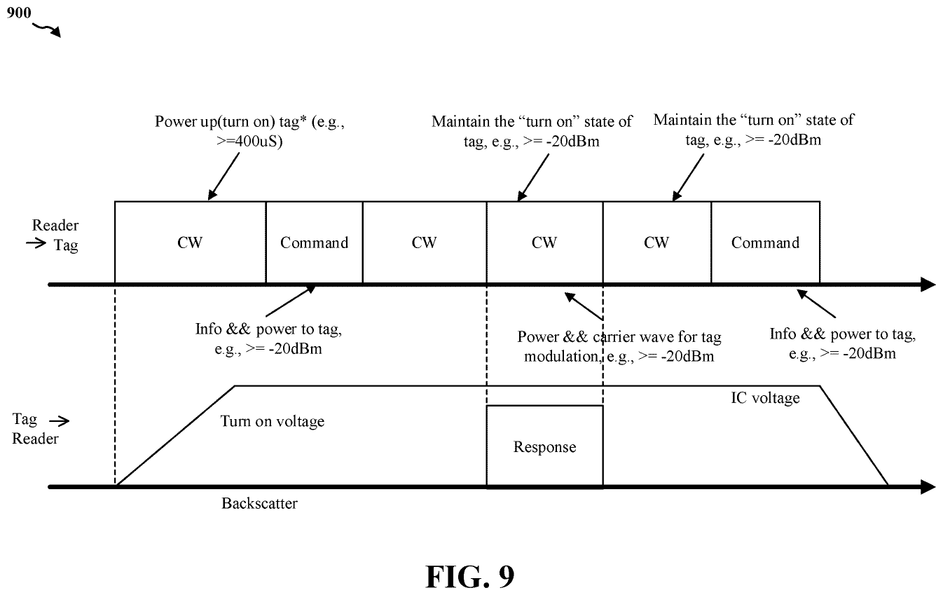

FIG. 9 is a diagram 900 illustrating example backscatter communication with interrogator (reader)-Talks-First (ITF) procedure between reader and tag. As illustrated in FIG. 9, the CW may be transmitted by the reader for powering on the tag. After powering on the tag, the reader may transmit a command, and then maintain the CW to keep the tag on.

If a wireless device is a PP UE to other sidelink/wearable/UEs in the network, the PP-UE may send best resources for each of the specific UEs it is helping (e.g., when those UEs are utilizing time-switching energy harvesting architecture). In some aspects, the concept of inter-UE coordination may be extended for indicating UEs with the preferred or non-preferred resources used for data communication or energy transfer (e.g., that may be used to power the EH UE). For example, a PP UE may inform one or more EH UEs that some time and frequency resources (e.g., that may be carrying another transmission) may be leveraged as energy source, even though the time and frequency resources are not carrying a dedicated energy signal. In some aspects, a PP UE may be assigned to power a number of EH UEs, where each of the EH UEs may be located in different locations and may have a difference distance from the PP UE. Charging rate of the EH UEs may be the same or different. The energy harvested or charging rate at an EH wireless device may be: P=ηPₜₓ|h|² Watts or E=P T Joules, where η represents RF-to-DC conversion efficiency, Pₜₓ represents the Tx radiated power, h represents channel coefficient (small- and large-scale fading), and T represents the total allocated time. If η is higher, more energy may be harvested and accumulated over time. The RF-to-DC conversion efficiency η may depend on circuit design, antenna efficiency, efficiency of voltage multiplier to convert RF to DC, accuracy of impedance matching between antenna and voltage multiplier, or the like. Increasing the transmit radiated power, Pₜₓ, may also increase the transferred power. Increasing charging time, T, may increase the accumulated energy at the EH wireless device.

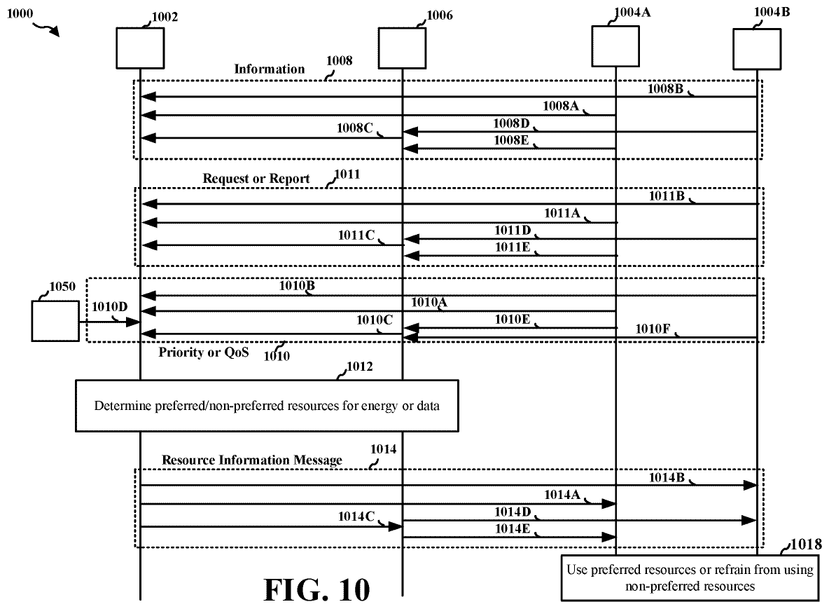

FIG. 10 is a diagram 1000 illustrating example communications between wireless devices. As illustrated in FIG. 10, one or more power provider wireless devices including a first power provider wireless device 1002, a non-EH wireless device 1006, and one or more energy harvesting wireless devices including a wireless device 1004A and wireless device 1004B are illustrated. In some aspects, the non-EH wireless device 1006 may be a PP wireless device or not a PP wireless device (e.g., a helper device). In some aspects, the one or more power provider wireless devices may be network entities such as UE, base station, or other types of devices in a wireless communication network. In some aspects, the one or more energy harvesting wireless devices may be network entities such as UE, base station, or other types of devices in a wireless communication network. In some aspects, a network entity may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, communication between the one or more power provider wireless devices or the one or more energy harvesting wireless devices may be downlink communication (e.g., including downlink configured or dynamic grants), uplink communication (e.g., including uplink configured or dynamic grants), sidelink communication, backhaul communication, or the like.

In some aspects, a PP wireless device, such as the wireless device 1002, may transmit at least one resource information message 1014 that may carry information indicative of a set of preferred resources (e.g., time and frequency resources) for energy transfer to an EH wireless device (e.g., the EH wireless device 1004A or the EH wireless device 1004B) based on information 1008 regarding the EH wireless device. In some aspects, the information 1008 regarding the wireless device may be received from the EH wireless device 1004A, the EH wireless device 1004B, or the wireless device 1006. For example, the information 1008 may be received in a message 1008A from the wireless device 1004A. As another example, the information 1008 may be received in a message 1008B from the wireless device 1004B. As another example, the information 1008 may be received in a message 1008C from the wireless device 1006. The wireless device 1006 may have received the information 1008 in a message 1008D from the EH wireless device 1004B or in a message 1008E from the EH wireless device 1004A. In some aspects, the message 1008A, the message 1008B, the message 1008C, the message 1008D, or the message 1008E may be carried in SCI.

In some aspects, the information 1008 may include distance, pathloss, amount of transmit power, charging rate, discharging rate, EH circuit, EH circuit architecture, RF-to-DC conversion efficiency η, EH parameters such as bands of charging or frequency of charging, charging rate for powering on or communication, or the like. In some aspects, the set of preferred resources for energy transfer may be determined by the PP wireless device, such as the wireless device 1002, at 1012. The set of preferred resources for energy transfer may be determined based on a threshold (e.g., based on metrics of the resources being larger than the threshold) that may be based on expected energy at the EH wireless device (e.g., the EH wireless device 1004A or the EH wireless device 1004B). The threshold or the metrics may be based on one or more of a reference signal received power (RSRP), a received signal strength indicator (RSSI), reference signal received quality (RSRQ), or signal to noise and interference ratio (SINR). In some aspects, the threshold may be determined by the EH wireless device (e.g., the EH wireless device 1004A or the EH wireless device 1004B) and transmitted to the PP wireless device while the EH wireless device is RRC connected. In some aspects, the threshold may be based at least in part on the information 1008, such as the distance, pathloss, amount of transmit power, charging rate, discharging rate, EH circuit, EH circuit architecture, RF-to-DC conversion efficiency η, EH parameters such as bands of charging or frequency of charging, charging rate for powering on or communication, or the like. In some aspects, in addition to preferred resources for energy transfer, the PP wireless device, such as the wireless device 1002 may also determine non-preferred resources for energy transfer at 1012 (e.g., based on the threshold, such as metrics including RSRP, RSSI, or RSSI being lower than a threshold) and transmit an information indicative of the non-preferred resources for energy transfer (e.g., as part of the at least one resource information message 1014). In some aspects, the at least one resource information message 1014 may be transmitted from the wireless device 1002 to the wireless device 1004A in a message 1014A. In some aspects, the at least one resource information message 1014 may be transmitted from the wireless device 1002 to the wireless device 1004B in a message 1014B. In some aspects, the at least one resource information message 1014 may be transmitted from the wireless device 1002 to the wireless device 1006 in a message 1014C. The wireless device 1006 may in turn transmit the at least one resource information message 1014 to the wireless device 1004A in a message 1014E or transmit the at least one resource information message 1014 to the wireless device 1004B in a message 1014D. In some aspects, the message 1014A, the message 1014B, the message 1014C, the message 1014D, or the message 1014E may be carried in SCI.

In some aspects, the preferred resources for energy transfer may provide a sufficient energy for the EH wireless device (e.g., the EH wireless device 1004A or the EH wireless device 1004B) and the non-preferred resources for energy transfer may provide an insufficient energy for the EH wireless device. In some aspects, the threshold may be determined such that the charging rate may satisfy a minimum input power at the EH wireless device. In some aspects, the EH wireless device may send a request for a charging rate to the PP wireless device (or another wireless device). In some aspects, different charging rates may be mapped to thresholds of different value. In some aspects, the requested charging rates may be dynamically changed (e.g., in a layer 1 (L1), layer 2 (L2), or layer 3 (L3) signaling where L1 may be the PHY layer, L2 may be the MAC layer or the logical link control layer, and L3 may be the network layer). L1 signaling may be control information, L2 signaling may be MAC-CE, and L3 signaling may be RRC signaling.

In some aspects, instead of the wireless device 1002, the non-EH wireless device 1006 may also determine the preferred or non-preferred resources for the energy transfer at 1012 and transmit the at least one resource information message 1014 that may include information indicative of the preferred or non-preferred resources for the energy transfer for one or more EH wireless devices (e.g., the wireless device 1004A or the wireless device 1004B). In some aspects, the wireless device 1002 may transmit, to the non-EH wireless device 1006, the at least one resource information message 1014 that may include for the preferred or non-preferred resources for the energy transfer for one or more EH wireless devices (e.g., the wireless device 1004A or the wireless device 1004B). In some aspects, the preferred or non-preferred resources for the energy transfer for the wireless device 1004A may be different or the same as preferred or non-preferred resources for the wireless device 1004B. In some aspects, the at least one resource information message 1014 may include the preferred or non-preferred resources for the energy transfer for the wireless device 1004A or preferred or non-preferred resources for the wireless device 1004B in a same information or different information. In some aspects, the wireless device 1002 or the non-EH wireless device 1006 may be powering the one or more EH wireless devices (e.g., the wireless device 1004A or the wireless device 1004B). In some aspects, the preferred resources for the energy transfer may be carrying data communication not intended for the one or more EH wireless devices (e.g., the wireless device 1004A or the wireless device 1004B) and may still be preferred for the energy transfer. In some aspects, the wireless device 1002 or the wireless device 1006 may also determine (e.g., at 1012), preferred resources for data communication or non-preferred resources for data communication for the one or more EH wireless devices (e.g., the wireless device 1004A or the wireless device 1004B) based on another threshold (e.g., that may also be determined based on the information 1008, such as the distance, pathloss, amount of transmit power, charging rate, discharging rate, EH circuit, EH circuit architecture, RF-to-DC conversion efficiency η, EH parameters such as bands of charging or frequency of charging, charging rate for powering on or communication, or the like). For example, in some examples where the preferred resources for the energy transfer are carrying data communication not intended for the one or more EH wireless devices, the resources may be preferred for energy transfer but not preferred for data communication for the one or more EH wireless devices.

In some aspects, there may be a dedicated master device, such as the wireless device 1002 or another device (e.g., which may be a dedicated node, programmable logic controller (PLC), primary UE, master UE, base station, or other devices) that may be responsible for determining the threshold, determining the preferred or non-preferred resources, or transmitting the at least one resource information message 1014 (after receiving information about the EH wireless devices and the PP wireless devices).

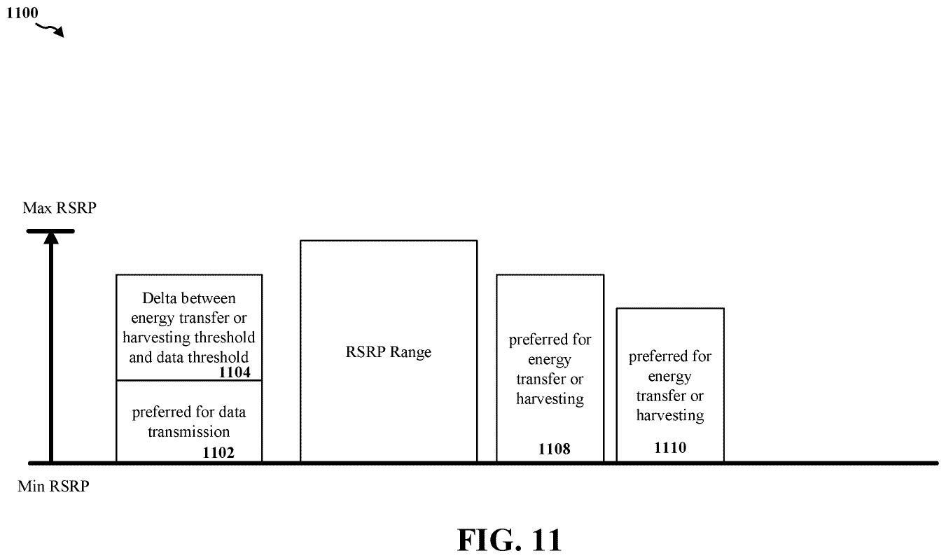

FIG. 11 is a diagram 1100 illustrating example thresholds. As illustrated in FIG. 11, RSRP thresholds are included as an example. In some aspects, the RSRP threshold for determining preferred or non-preferred resources for energy transfer resources may be greater, equal to, or less than the RSRP threshold for determining preferred or non-preferred resources for data communication. For example, a RSRP threshold for the energy transfer may be based on whether the energy signal is generated based on a configuration known to the EH wireless devices so that the receivers can cancel the energy signal. For example, if the energy signal is generated based on a configuration known to the EH wireless devices, even if there is a data on the current resource or collision, energy signal may still be sent. As illustrated in FIG. 11, 1102 may be a RSRP threshold for determining whether resources are preferred for data communication for a first EH wireless device. The RSRP threshold 1104 may be a delta value between RSRP threshold for determining whether resources are preferred for data communication and a RSRP threshold for determining whether resources are preferred for energy transfer. There may be different RSRP threshold 1108 and RSRP threshold 1110 for determining whether resources are preferred for energy transfer for other EH wireless devices. In some aspects, the RSRP threshold for determining preferred resources for energy transfer resources may be greater than or equal to the RSRP threshold for determining preferred resources for data communication because the EH wireless device may use a higher energy to efficiently charge.

In some aspects, at 1012, the wireless device 1002 or the wireless device 1006 may determine preferred or non-preferred resources for energy transfer after determining and based on preferred or non-preferred resources for data communication. In some aspects, at 1012, the wireless device 1002 or the wireless device 1006 may determine preferred or non-preferred resources for data communication after determining and based on preferred or non-preferred resources for energy transfer.

In some aspects, the RSRP threshold for determining preferred or non-preferred resources for energy transfer resources or the RSRP threshold for determining preferred or non-preferred resources for data communication may be based on a priority or quality of service (QoS) 1010 of the data communication. In some aspects, an intended recipient of the data communication may be different from the one or more EH wireless devices. In some aspects, the priority or the QoS 1010 may be transmitted from the wireless device 1004A to the wireless device 1002 in a message 1010A. In some aspects, the priority or the QoS 1010 may be transmitted from the wireless device 1004B to the wireless device 1002 in a message 1010B. In some aspects, the priority or the QoS 1010 may be transmitted from the wireless device 1006 to the wireless device 1002 in a message 1010C. The wireless device 1006 may receive the priority or the QoS 1010 from the wireless device 1004A in a message 1011E or receive the priority or the QoS 1010 from the wireless device 1004B in a message 1010F. In some aspects, the priority or the QoS 1010 may be transmitted from another wireless device 1050 to the wireless device 1002. In some aspects, the message 1010A, the message 1010B, the message 1010C, the message 1010D, the message 1010E, or the message 1010F may be carried in SCI.

In some aspects, remaining packet delay budget of the data communication may be indicated to the wireless device 1002 or the wireless device 1006 (e.g., via SCI 1 or SCI 2). In some aspects, remaining packet delay budget of the data at the EH wireless device may be signaled from the EH device to the wireless device 1002 or the wireless device 1006.

In some aspects, the RSRP threshold for determining preferred or non-preferred resources for energy transfer resources or the RSRP threshold for determining or non-preferred resources for data communication may be further based on a charging rate to be used at the EH wireless device.

In some aspects, based on the at least one resource information message 1014, the one or more EH wireless devices (e.g., the wireless device 1004A or the wireless device 1004B) may, at 1018, use the information indicative of preferred or non-preferred resources for energy transfer or data communication to: 1) avoid energy resources that are not preferred (e.g., as if the energy resources are data where no collision is allowed since the data receiver might not be able to resolve data from energy), 2) cancel an energy signal that may be non-preferred (e.g., based on knowing the energy resource configuration), or 3) use resources for energy transfer or data communication (e.g., resources used for carrying a transmission). In some aspects, the at least one resource information message 1014 may be transmitted based on SCI. In some aspects, an SCI associated with the transmission may indicate whether the transmission is an energy signal or a data signal. In some aspects, an SCI may be used for broadcasting configuration of energy resources to enable cancellation by the EH wireless devices. In some aspects, transmission of the at least one resource information message 1014 or the determination of the non-preferred or preferred resources may be triggered by a request (e.g., request or report 1011), which may be transmitted in a layer 1 (L1), layer 2 (L2), or layer 3 (L3) signaling where L1 may be the PHY layer, L2 may be the MAC layer or the logical link control layer, and L3 may be the network layer). L1 signaling may be control information, L2 signaling may be MAC-CE, and L3 signaling may be RRC signaling. In some aspects, the request or report 1011 may be transmitted from the wireless device 1004A to the wireless device 1002 in a message 1011A. In some aspects, the request or report 1011 may be transmitted from the wireless device 1004B to the wireless device 1002 in a message 1011B. In some aspects, the request or report 1011 may be transmitted from the wireless device 1006 to the wireless device 1002 in a message 1011C. The wireless device 1006 may receive the request or report 1011 from the wireless device 1004A in a message 1011E or receive the request or report 1011 from the wireless device 1004B in a message 1011D. In some aspects, the message 1011A, the message 1011B, the message 1011C, the message 1011D, or the message 1011E may be carried in SCI.

In some aspects, transmission of the at least one resource information message 1014 or the determination of the non-preferred or preferred resources may be triggered based on information regarding one or more conditions associated with the EH wireless devices (which may be included in the request or report 1011). The one or more conditions may include at least one of: a charging rate drop or increase by an amount (e.g., request or report 1011 may include charging rate information), a discharging rate drop or increase by an amount (e.g., request or report 1011 may include discharging rate information), movement to another location or zone of the PP wireless device or the EH wireless device (e.g., may include movement information), or change of EH parameters such as band of operation, frequency range, RF tuning or BW or resource pool (e.g., request or report 1011 may include radio operational change information). The term “radio operational change” may refer to at least one of: change of band of operation, change of frequency range or RF tuning, change of BW or resource pool, or the like. The term “charging rate change information” may refer to charging rate changes, predicted charging rate changes, statistics related to charging rate changes, or time information (e.g., time stamp or duration) associated with charging rate changes or predicted charging rate changes. The term “discharging rate change information” may refer to discharging rate changes, predicted discharging rate changes, statistics related to discharging rate changes, or time information (e.g., time stamp or duration) associated with discharging rate changes or predicted discharging rate changes.

In some aspects, the at least one resource information message 1014 may be a multiplexed message that include an inter-UE coordination message. In some aspects, the at least one resource information message 1014 may include information indicative of preferred resources for energy transfer and preferred resources for data communication. In some aspects, the at least one resource information message 1014 may include information indicative of non-preferred resources for energy transfer and information indicative of preferred resources for data communication. In some aspects, the at least one resource information message 1014 may preferred information indicative of preferred resources for energy transfer and information indicative of non-preferred resources for data communication. In some aspects, the at least one resource information message 1014 may include information indicative of non-preferred resources for energy transfer and information indicative of non-preferred resources for data communication. In some aspects, the information may be multiplexed before encoding (e.g., in raw bit level) or after encoding (e.g., in RE or RB allocation level or a set of RBs allocated for different information). In some aspects, the at least one resource information message 1014 may include information indicative of preferred or non-preferred resources for energy transfer or information indicative of preferred or non-preferred resources for data communication. In some aspects, separate messages of 1014 may be sent to the different EH wireless devices, such as the wireless device 1004A and the wireless device 1004B. In some aspects, the at least one resource information message 1014 may include one or more bits to distinguish between information indicative of preferred or non-preferred resources for energy transfer and information indicative of preferred or non-preferred resources for data communication.

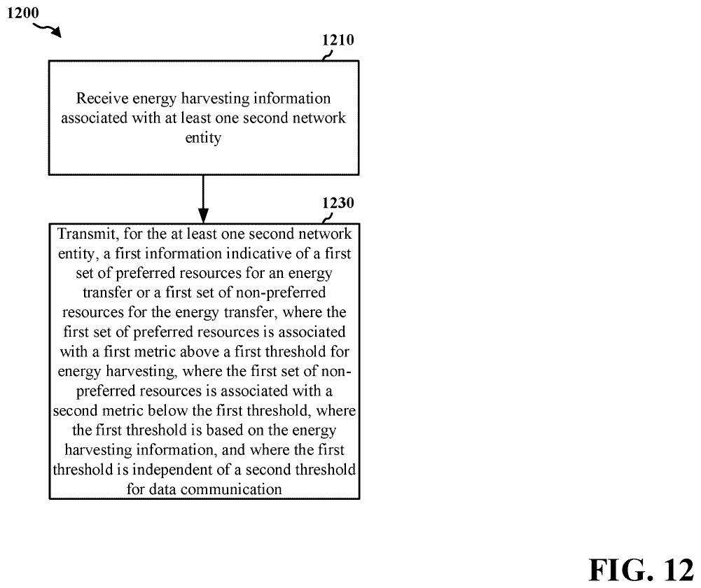

FIG. 12 is a flowchart 1200 of a method of wireless communication. The method may be performed by a first network entity (e.g., the UE 104, the wireless device 1002, the wireless device 1006, the base station 102, the network entity 1602, the network entity 1702, the apparatus 1604).

At 1210, the network entity may receive energy harvesting information associated with at least one second network entity. For example, the wireless device 1002 may receive energy harvesting information (e.g., 1008) associated with at least one second network entity (e.g., the wireless device 1004A or the wireless device 1004B). In some aspects, 1210 may be performed by the coordination component 198.

At 1230, the network entity may transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. For example, the wireless device 1002 may transmit, for the at least one second network entity, a first information (e.g., in resource information message 1014) indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, 1230 may be performed by the coordination component 198.

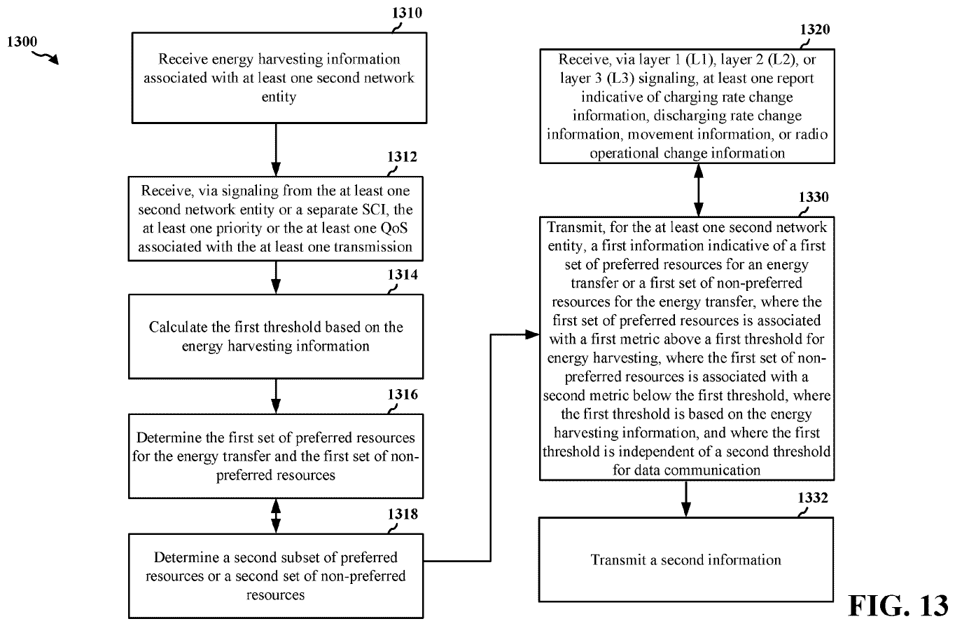

FIG. 13 is a flowchart 1300 of a method of wireless communication. The method may be performed by a first network entity (e.g., the UE 104, the wireless device 1002, the wireless device 1006, the base station 102, the network entity 1602, the network entity 1702, the apparatus 1604).

At 1310, the network entity may receive energy harvesting information associated with at least one second network entity. For example, the wireless device 1002 may receive energy harvesting information (e.g., 1008) associated with at least one second network entity (e.g., the wireless device 1004A or the wireless device 1004B). In some aspects, 1310 may be performed by the coordination component 198. In some aspects, the energy harvesting information includes one or more of: information regarding at least one energy harvesting circuit associated with the at least one second network entity, at least one efficiency associated with the at least one second network entity, at least one band of charging or at least one frequency of charging associated with the at least one second network entity, or at least one specified charging rate associated with the at least one second network entity.

At 1314, the network entity may determine the first threshold based on the energy harvesting information. For example, the wireless device 1002 may determine the first threshold (e.g., as part of 1012) based on the energy harvesting information. In some aspects, 1314 may be performed by the coordination component 198. In some aspects, the first threshold is based on one or more of: at least one priority or at least one quality of service (QoS) associated with at least one transmission enabled by the energy transfer or the at least one specified charging rate. In some aspects, the network entity may receive, via signaling from the at least one second network entity or a separate SCI, the at least one priority or the at least one QoS associated with the at least one transmission. In some aspects, at 1312, the network entity (e.g., the wireless device 1002) may receive, via signaling from the at least one second network entity (e.g., 1010A or 1010B) or a separate SCI (e.g., 1010D), the at least one priority or the at least one QoS associated with the at least one transmission. In some aspects, 1312 may be performed by the coordination component 198.

At 1316, the network entity may determine the first set of preferred resources for the energy transfer and the first set of non-preferred resources for the energy transfer. For example, the wireless device 1002 may determine (e.g., as part of 1012) the first set of preferred resources for the energy transfer and the first set of non-preferred resources for the energy transfer. In some aspects, 1316 may be performed by the coordination component 198.

At 1318, the network entity may determine, for the at least one second network entity, a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. For example, the wireless device 1002 may determine (e.g., as part of 1012), for the at least one second network entity, a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, 1318 may be performed by the coordination component 198. In some aspects, the metric is one of a reference signal received power (RSRP), a received signal strength indicator (RSSI), a reference signal received quality (RSRQ), or signal to noise and interference ratio (SINR). In some aspects, the RSRP, RSSI, RSRQ, or SINR may be associated with L1 or L3.

In some aspects, the network entity may determine the first set of preferred resources for the energy transfer and the first set of non-preferred resources for the energy transfer based on (e.g., after) the second set of preferred resources for the data communication or the second set of non-preferred resources for the data communication. For example, the wireless device 1002 may determine the first set of preferred resources for the energy transfer and the first set of non-preferred resources for the energy transfer based on (e.g., after) the second set of preferred resources for the data communication or the second set of non-preferred resources for the data communication. In some aspects, to determine the second set of preferred resources for the data communication or the second set of non-preferred resources for the data communication, the network entity may determine the second set of preferred resources for the data communication or the second set of non-preferred resources for the data communication based on (e.g., after) the first set of preferred resources for the energy transfer and the first set of non-preferred resources for the energy transfer. For example, the wireless device 1002 may determine the second set of preferred resources for the data communication or the second set of non-preferred resources for the data communication based on (e.g., after) the first set of preferred resources for the energy transfer and the first set of non-preferred resources for the energy transfer. In some aspects, the first information or the second information may be transmitted based on a request (e.g., 1011) via layer 1 (L1), layer 2 (L2), or layer 3 (L3) signaling. L1 may be the PHY layer, L2 may be the MAC layer or the logical link control layer, L3 may be the network layer. L1 signaling may be control information, L2 signaling may be MAC-CE, and L3 signaling may be RRC signaling.

At 1320, the network entity may receive, via based on layer 1 (L1), layer 2 (L2), or layer 3 (L3) signaling, at least one report indicative of charging rate change information, discharging rate change information, movement information, or radio operational change information. For example, the wireless device 1002 may receive, via based on layer 1 (L1), layer 2 (L2), or layer 3 (L3) signaling, at least one report (e.g., 1011) indicative of charging rate change information, discharging rate change information, movement information, or radio operational change information. In some aspects, 1320 may be performed by the coordination component 198. In some aspects, the network entity may transmit the first information based on the charging rate change information, the discharging rate change information, the movement information, or the radio operational change information.

At 1330, the network entity may transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. For example, the wireless device 1002 may transmit, for the at least one second network entity, a first information (e.g., in resource information message 1014) indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, 1330 may be performed by the coordination component 198. In some aspects, to transmit the first information, the network entity may transmit the first information to the at least one second network entity (e.g., the wireless device 1004A or the wireless device 1004B) or a third network entity (e.g., the wireless device 1006), where the at least one second network entity is at least one energy harvesting network entity and the third network entity is a non-energy harvesting network entity.

At 1332, the network entity may transmit second information indicative of the second set of preferred resources for the data communication or the second set of non-preferred resources for the data communication. For example, the wireless device 1002 may transmit second information (e.g., in the at least one resource information message 1014) indicative of the second set of preferred resources for the data communication or the second set of non-preferred resources for the data communication. In some aspects, 1332 may be performed by the coordination component 198. In some aspects, the network entity may transmit, for the at least one second network entity (e.g., the wireless device 1004A or the wireless device 1004B), second information indicative of the second set of preferred resources for the data communication or the second set of non-preferred resources for the data communication. In some aspects, the network entity may transmit the second information to the at least one second network entity (e.g., the wireless device 1004A or the wireless device 1004B) or a third network entity (e.g., the wireless device 1006), where the at least one second network entity is at least one energy harvesting network entity and the third network entity is a non-energy harvesting network entity. In some aspects, the at least one second network entity corresponds to a single network entity (e.g., one of the wireless device 1004A or the wireless device 1004B), and the network entity may multiplexing, at a bit level or a RE level, the first information and the second information, where the first information is indicative of the first set of preferred resources for the energy transfer, where the second information is indicative of the second set of preferred resources for the data communication. In some aspects, the at least one second network entity corresponds to a single network entity (e.g., one of the wireless device 1004A or the wireless device 1004B), and the network entity may multiplexing, at a bit level or a RE level, the first information and the second information, where the first information is indicative of the first set of non-preferred resources for the energy transfer, where the second information is indicative of the second set of preferred resources for the data communication. In some aspects, the at least one second network entity corresponds to a single network entity (e.g., one of the wireless device 1004A or the wireless device 1004B), and the network entity may multiplexing, at a bit level or a RE level, the first information and the second information, where the first information is indicative of the first set of preferred resources for the energy transfer, where the second information is indicative of the second set of non-preferred resources for the data communication. In some aspects, the at least one second network entity corresponds to a single network entity (e.g., one of the wireless device 1004A or the wireless device 1004B), and the network entity may multiplexing, at a bit level or a RE level, the first information and the second information, where the first information is indicative of the first set of non-preferred resources for the energy transfer, where the second information is indicative of the second set of non-preferred resources for the data communication.

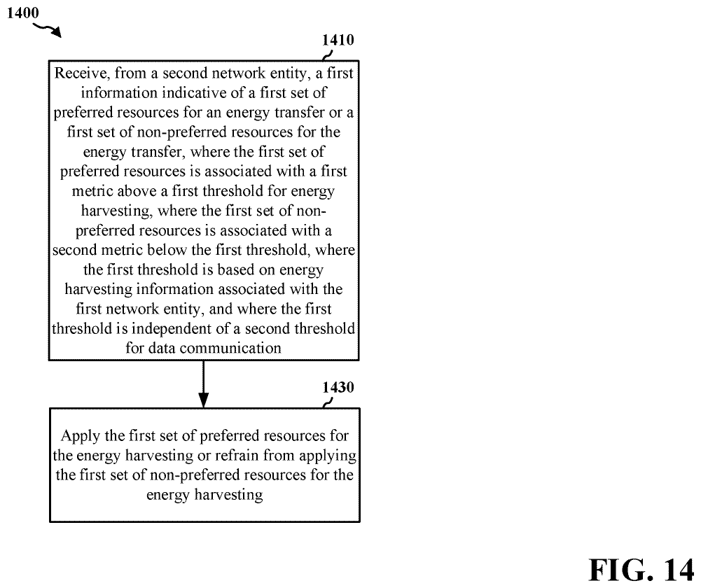

FIG. 14 is a flowchart 1400 of a method of wireless communication. The method may be performed by a first network entity (e.g., the UE 104, the wireless device 1004A or the wireless device 1004B, the base station 102, the network entity 1602, the network entity 1702, the apparatus 1604).

At 1410, the network entity may receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. For example, the wireless device 1004A may receive, from a second network entity, a first information (e.g., 1014) indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, 1410 may be performed by the coordination component 198.

At 1430, the network entity may apply the first set of preferred resources for the energy harvesting or refrain from applying the first set of non-preferred resources for the energy harvesting. For example, the wireless device 1004A may apply (e.g., at 1018) the first set of preferred resources for the energy harvesting or refrain from applying the first set of non-preferred resources for the energy harvesting. In some aspects, 1430 may be performed by the coordination component 198.

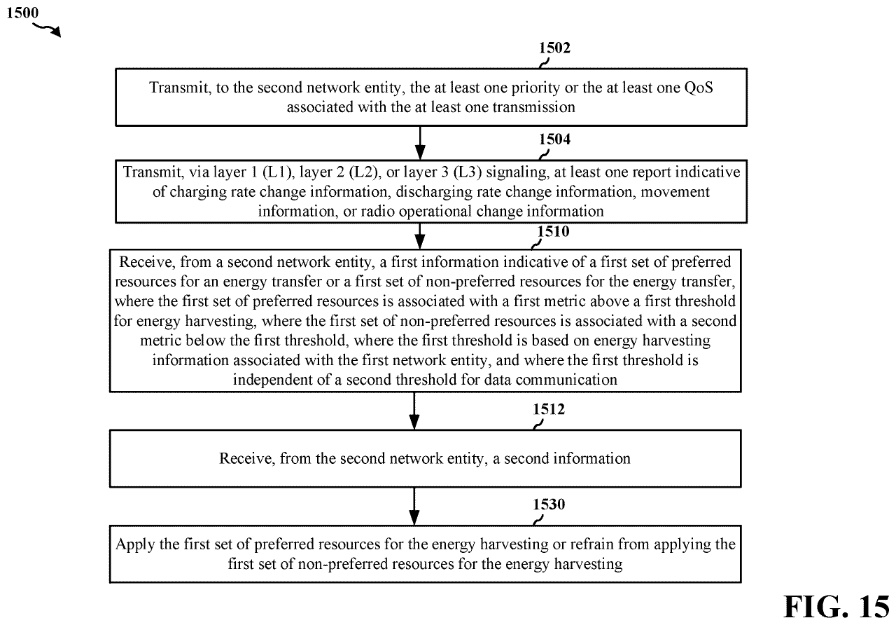

FIG. 15 is a flowchart 1500 of a method of wireless communication. The method may be performed by a first network entity (e.g., the UE 104, the wireless device 1004A or the wireless device 1004B, the base station 102, the network entity 1602, the network entity 1702, the apparatus 1604).

At 1502, the network entity may transmit, to the second network entity, the at least one priority or the at least one QoS associated with the at least one transmission. For example, the wireless device 1004A may transmit, to the second network entity, the at least one priority or the at least one QoS (e.g., in 1010A) associated with the at least one transmission. In some aspects, 1502 may be performed by the coordination component 198.

At 1504, the network entity may transmit, via based on layer 1 (L1), layer 2 (L2), or layer 3 (L3) signaling, at least one report (e.g., 1011) indicative of charging rate change information, discharging rate change information, movement information, or radio operational change information. In some aspects, 1504 may be performed by the coordination component 198.

At 1510, the network entity may receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. For example, the wireless device 1004A may receive, from a second network entity, a first information (e.g., 1014) indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, 1510 may be performed by the coordination component 198. In some aspects, the metric is one of a reference signal received power (RSRP), a received signal strength indicator (RSSI), or signal to noise and interference ratio (SINR). In some aspects, the first threshold is based on one or more of: at least one priority or at least one quality of service (QoS) associated with at least one transmission enabled by the energy transfer or the specified charging rate. In some aspects, the energy harvesting information includes one or more of: information regarding an energy harvesting circuit associated with the first network entity, an efficiency associated with the first network entity, a band of charging or a frequency of charging associated with the first network entity, or a specified charging rate associated with the first network entity.

At 1512, the network entity may receive, from the second network entity, second information indicative of a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. For example, the wireless device 1004A may receive, from the second network entity, second information (e.g., in 1014) indicative of a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, 1512 may be performed by the coordination component 198.

At 1530, the network entity may apply the first set of preferred resources for the energy harvesting or refrain from applying the first set of non-preferred resources for the energy harvesting. For example, the wireless device 1004A may apply (e.g., at 1018) the first set of preferred resources for the energy harvesting or refrain from applying the first set of non-preferred resources for the energy harvesting. In some aspects, 1430 may be performed by the coordination component 198.

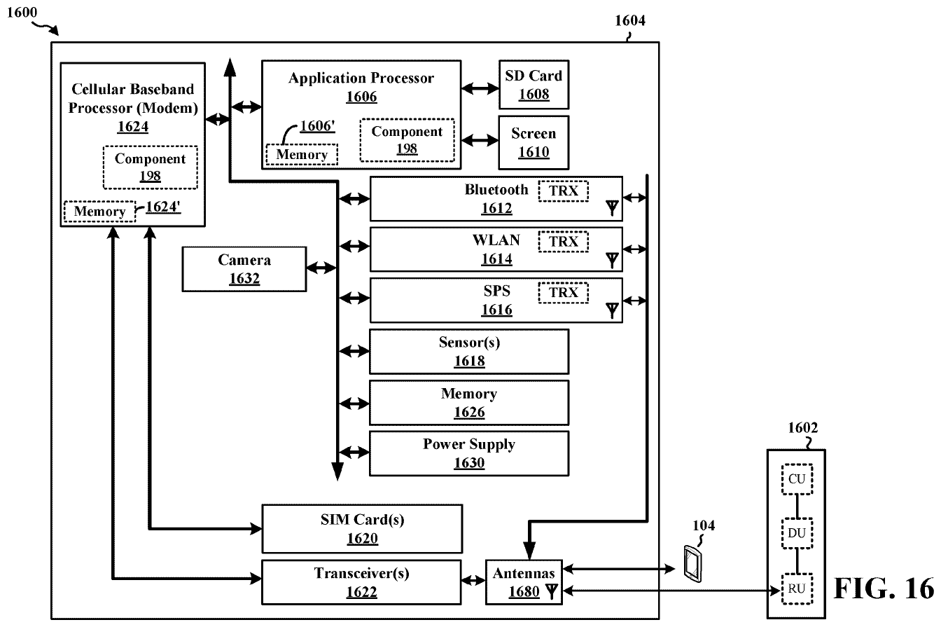

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, a satellite system module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the satellite system module 1616 may include an on-chip transceiver (TRX)/receiver (RX). The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described herein. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed herein, the coordination component 198 may be configured to receive energy harvesting information associated with at least one second network entity. In some aspects, the coordination component 198 may be further configured to transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, the coordination component 198 may be configured to receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, the coordination component 198 may be further configured to apply the first set of preferred resources for the energy harvesting or refrain from applying the first set of non-preferred resources for the energy harvesting. The coordination component 198 may be within the cellular baseband processor 1624, the application processor 1606, or both the cellular baseband processor 1624 and the application processor 1606. The coordination component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving energy harvesting information associated with at least one second network entity. In some aspects, the apparatus 1604 may further include means for transmitting, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, the apparatus 1604 may further include means for transmitting the first information based on a request via based on layer 1 (L1), layer 2 (L2), or layer 3 (L3) signaling. In some aspects, the apparatus 1604 may further include means for transmitting the first information based on the charging rate change information, the discharging rate change information, the movement information, or the radio operational change information. In some aspects, the apparatus 1604 may further include means for receiving, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, the apparatus 1604 may further include means for applying the first set of preferred resources for the energy harvesting or refrain from applying the first set of non-preferred resources for the energy harvesting. In some aspects, the apparatus 1604 may further include means for determining the first threshold based on the energy harvesting information. In some aspects, the apparatus 1604 may further include means for determining, for the at least one second network entity, a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, the apparatus 1604 may further include means for determining the first set of preferred resources for the energy transfer and the first set of non-preferred resources for the energy transfer based on (e.g., after) the second set of preferred resources for the data communication or the second set of non-preferred resources for the data communication. In some aspects, the apparatus 1604 may further include means for determining the second set of preferred resources for the data communication or the second set of non-preferred resources for the data communication based on (e.g., after) the first set of preferred resources for the energy transfer and the first set of non-preferred resources for the energy transfer. In some aspects, the apparatus 1604 may further include means for transmitting, for the at least one second network entity, second information indicative of the second set of preferred resources for the data communication or the second set of non-preferred resources for the data communication. In some aspects, the apparatus 1604 may further include means for transmitting the second information to the at least one second network entity or a third network entity, where the at least one second network entity is at least one energy harvesting network entity and the third network entity is a non-energy harvesting network entity. In some aspects, the apparatus 1604 may further include means for multiplexing, at a bit level or a RE level, the first information and the second information, where the first information is indicative of the first set of preferred resources for the energy transfer, where the second information is indicative of the second set of preferred resources for the data communication. In some aspects, the apparatus 1604 may further include means for multiplexing, at a bit level or a RE level, the first information and the second information, where the first information is indicative of the first set of non-preferred resources for the energy transfer, where the second information is indicative of the second set of preferred resources for the data communication. In some aspects, the apparatus 1604 may further include means for multiplexing, at a bit level or a RE level, the first information and the second information, where the first information is indicative of the first set of preferred resources for the energy transfer, where the second information is indicative of the second set of non-preferred resources for the data communication. In some aspects, the apparatus 1604 may further include means for multiplexing, at a bit level or a RE level, the first information and the second information, where the first information is indicative of the first set of non-preferred resources for the energy transfer, where the second information is indicative of the second set of non-preferred resources for the data communication. In some aspects, the apparatus 1604 may further include means for transmitting the first information to the at least one second network entity or a third network entity, where the at least one second network entity is at least one energy harvesting network entity and the third network entity is a non-energy harvesting network entity. In some aspects, the apparatus 1604 may further include means for receiving, via signaling from the at least one second network entity or a separate SCI, the at least one priority or the at least one QoS associated with the at least one transmission. In some aspects, the apparatus 1604 may further include means for receiving, via signaling from the at least one second network entity or a separate SCI, the at least one priority or the at least one QoS associated with the at least one transmission. In some aspects, the apparatus 1604 may further include means for receiving, via based on layer 1 (L1), layer 2 (L2), or layer 3 (L3) signaling, at least one report indicative of charging rate change information, discharging rate change information, movement information, or radio operational change information. In some aspects, the apparatus 1604 may further include means for receiving, from the second network entity, second information indicative of a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, the apparatus 1604 may further include means for transmitting, to the second network entity, the at least one priority or the at least one QoS associated with the at least one transmission. In some aspects, the apparatus 1604 may further include means for transmitting, via based on layer 1 (L1), layer 2 (L2), or layer 3 (L3) signaling, at least one report indicative of charging rate change information, discharging rate change information, movement information, or radio operational change information. The means may be the coordination component 198 of the apparatus 1604 configured to perform the functions recited by the means. As described herein, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

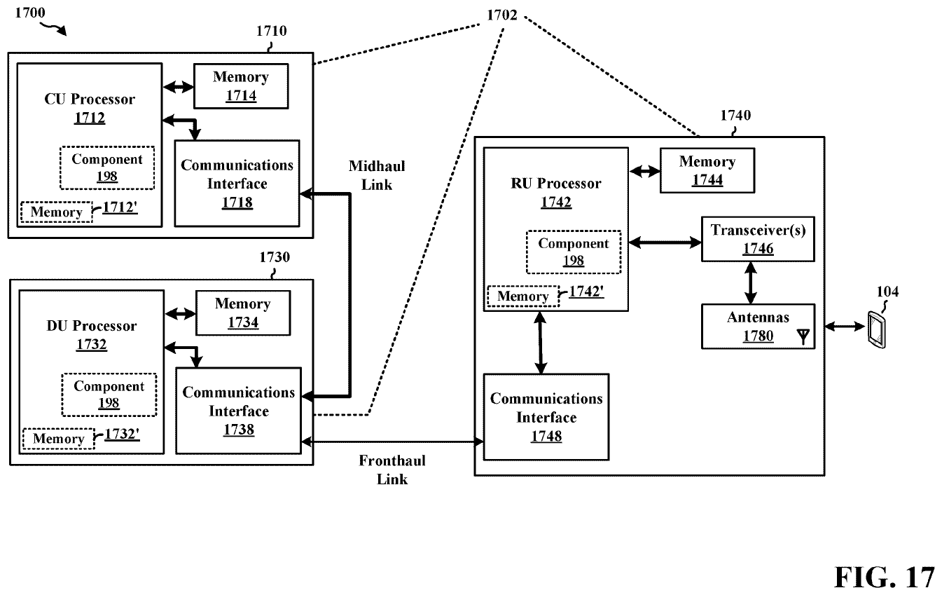

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 198, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the coordination component 198 may be configured to receive energy harvesting information associated with at least one second network entity. In some aspects, the coordination component 198 may be further configured to transmit, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, the coordination component 198 may be configured to receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, the coordination component 198 may be further configured to apply the first set of preferred resources for the energy harvesting or refrain from applying the first set of non-preferred resources for the energy harvesting. The coordination component 198 may be within one or more processors of one or more of the CU 1710, DU 1730, and the RU 1740. The coordination component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for receiving energy harvesting information associated with at least one second network entity. In some aspects, the network entity 1702 may further include means for transmitting, for the at least one second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication. In some aspects, the network entity 1702 may further include means for transmitting the first information based on a request via based on layer 1 (L1), layer 2 (L2), or layer 3 (L3) signaling. In some aspects, the network entity 1702 may further include means for transmitting the first information based on the charging rate change information, the discharging rate change information, the movement information, or the radio operational change information. In some aspects, the network entity 1702 may further include means for receiving, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication. In some aspects, the network entity 1702 may further include means for applying the first set of preferred resources for the energy harvesting or refrain from applying the first set of non-preferred resources for the energy harvesting. In some aspects, the network entity 1702 may further include means for determining the first threshold based on the energy harvesting information. In some aspects, the network entity 1702 may further include means for determining, for the at least one second network entity, a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, the network entity 1702 may further include means for determining the first set of preferred resources for the energy transfer and the first set of non-preferred resources for the energy transfer based on (e.g., after) the second set of preferred resources for the data communication or the second set of non-preferred resources for the data communication. In some aspects, the network entity 1702 may further include means for determining the second set of preferred resources for the data communication or the second set of non-preferred resources for the data communication based on (e.g., after) the first set of preferred resources for the energy transfer and the first set of non-preferred resources for the energy transfer. In some aspects, the network entity 1702 may further include means for transmitting, for the at least one second network entity, second information indicative of the second set of preferred resources for the data communication or the second set of non-preferred resources for the data communication. In some aspects, the network entity 1702 may further include means for transmitting the second information to the at least one second network entity or a third network entity, where the at least one second network entity is at least one energy harvesting network entity and the third network entity is a non-energy harvesting network entity. In some aspects, the network entity 1702 may further include means for multiplexing, at a bit level or a RE level, the first information and the second information, where the first information is indicative of the first set of preferred resources for the energy transfer, where the second information is indicative of the second set of preferred resources for the data communication. In some aspects, the network entity 1702 may further include means for multiplexing, at a bit level or a RE level, the first information and the second information, where the first information is indicative of the first set of non-preferred resources for the energy transfer, where the second information is indicative of the second set of preferred resources for the data communication. In some aspects, the network entity 1702 may further include means for multiplexing, at a bit level or a RE level, the first information and the second information, where the first information is indicative of the first set of preferred resources for the energy transfer, where the second information is indicative of the second set of non-preferred resources for the data communication. In some aspects, the network entity 1702 may further include means for multiplexing, at a bit level or a RE level, the first information and the second information, where the first information is indicative of the first set of non-preferred resources for the energy transfer, where the second information is indicative of the second set of non-preferred resources for the data communication. In some aspects, the network entity 1702 may further include means for transmitting the first information to the at least one second network entity or a third network entity, where the at least one second network entity is at least one energy harvesting network entity and the third network entity is a non-energy harvesting network entity. In some aspects, the network entity 1702 may further include means for receiving, via signaling from the at least one second network entity or a separate SCI, the at least one priority or the at least one QoS associated with the at least one transmission. In some aspects, the network entity 1702 may further include means for receiving, via signaling from the at least one second network entity or a separate SCI, the at least one priority or the at least one QoS associated with the at least one transmission. In some aspects, the network entity 1702 may further include means for receiving, via based on layer 1 (L1), layer 2 (L2), or layer 3 (L3) signaling, at least one report indicative of charging rate change information, discharging rate change information, movement information, or radio operational change information. In some aspects, the network entity 1702 may further include means for receiving, from the second network entity, second information indicative of a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold. In some aspects, the network entity 1702 may further include means for transmitting, to the second network entity, the at least one priority or the at least one QoS associated with the at least one transmission. In some aspects, the network entity 1702 may further include means for transmitting, via based on layer 1 (L1), layer 2 (L2), or layer 3 (L3) signaling, at least one report indicative of charging rate change information, discharging rate change information, movement information, or radio operational change information. The means may be the coordination component 198 of the network entity 1702 configured to perform the functions recited by the means. As described herein, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: receive energy harvesting information associated with at least one second network entity; and transmit, for the at least one second network entity, first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on the energy harvesting information, and where the first threshold is independent of a second threshold for data communication.

Aspect 2 is the first network entity of aspect 1, where the at least one processor is configured to: determine the first threshold based on the energy harvesting information.

Aspect 3 is the first network entity of any of aspects 1-2, where the at least one processor is configured to: determine, for the at least one second network entity, a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold.

Aspect 4 is the first network entity of any of aspects 1-3, where each of the first metric, the second metric, the third metric, or the fourth metric is one of a reference signal received power (RSRP), a received signal strength indicator (RSSI), or signal to noise and interference ratio (SINR).

Aspect 5 is the first network entity of any of aspects 1-4, where the at least one processor is configured to: determine the first set of preferred resources for the energy transfer and the first set of non-preferred resources for the energy transfer based on the second set of preferred resources for the data communication or the second set of non-preferred resources for the data communication.

Aspect 6 is the first network entity of any of aspects 1-4, where, to determine the second set of preferred resources for the data communication or the second set of non-preferred resources for the data communication, the at least one processor is configured to: determine the second set of preferred resources for the data communication or the second set of non-preferred resources for the data communication based on the first set of preferred resources for the energy transfer and the first set of non-preferred resources for the energy transfer.

Aspect 7 is the first network entity of any of aspects 1-6, where the at least one processor is configured to: transmit, for the at least one second network entity, second information indicative of the second set of preferred resources for the data communication or the second set of non-preferred resources for the data communication.

Aspect 8 is the first network entity of any of aspects 1-7, where, to transmit the second information, the at least one processor is configured to: transmit the second information to the at least one second network entity or a third network entity, where the at least one second network entity is at least one energy harvesting network entity and the third network entity is a non-energy harvesting network entity.

Aspect 9 is the first network entity of any of aspects 1-8, where the at least one second network entity corresponds to a single network entity, and where, to transmit the first information and the second information, the at least one processor is configured to: multiplex, at a bit level or a resource element (RE) level, the first information and the second information, where the first information is indicative of the first set of preferred resources for the energy transfer, and where the second information is indicative of the second set of preferred resources for the data communication.

Aspect 10 is the first network entity of any of aspects 1-8, where the at least one second network entity corresponds to a single network entity, and where the at least one processor is configured to: multiplex, at a bit level or a resource element (RE) level, the first information and the second information, where the first information is indicative of the first set of non-preferred resources for the energy transfer, and where the second information is indicative of the second set of preferred resources for the data communication.

Aspect 11 is the first network entity of any of aspects 1-8, where the at least one second network entity corresponds to a single network entity, and where the at least one processor is configured to: multiplex, at a bit level or a resource element (RE) level, the first information and the second information, where the first information is indicative of the first set of preferred resources for the energy transfer, and where the second information is indicative of the second set of non-preferred resources for the data communication.

Aspect 12 is the first network entity of any of aspects 1-8, where the at least one second network entity corresponds to a single network entity, and where the at least one processor is configured to: multiplex, at a bit level or a resource element (RE) level, the first information and the second information, where the first information is indicative of the first set of non-preferred resources for the energy transfer, and where the second information is indicative of the second set of non-preferred resources for the data communication.

Aspect 13 is the first network entity of any of aspects 1-12, where, to transmit the first information, the at least one processor is configured to: transmit the first information to the at least one second network entity or a third network entity, where the at least one second network entity is at least one energy harvesting network entity and the third network entity is a non-energy harvesting network entity.

Aspect 14 is the first network entity of any of aspects 1-13, where the energy harvesting information includes one or more of: information regarding at least one energy harvesting circuit associated with the at least one second network entity, at least one efficiency associated with the at least one second network entity, at least one band of charging or at least one frequency of charging associated with the at least one second network entity, or at least one specified charging rate associated with the at least one second network entity.

Aspect 15 is the first network entity of any of aspects 1-14, where the first threshold is based on one or more of: at least one priority or at least one quality of service (QoS) associated with at least one transmission enabled by the energy transfer or the at least one specified charging rate.

Aspect 16 is the first network entity of any of aspects 1-15, where the at least one processor is configured to: receive, via signaling from the at least one second network entity or a separate sidelink control information (SCI), the at least one priority or the at least one QoS associated with the at least one transmission.

Aspect 17 is the first network entity of any of aspects 1-16, where the second threshold is based on one or more of: at least one priority or at least one quality of service (QoS) associated with the data communication.

Aspect 18 is the first network entity of any of aspects 1-17, where, to transmit the first information, the at least one processor is configured to transmit the first information based on a request via layer 1 (L1), layer 2 (L2), or layer 3 (L3) signaling.

Aspect 19 is the first network entity of any of aspects 1-18, where the at least one processor is configured to: receive, via layer 1 (L1), layer 2 (L2), or layer 3 (L3) signaling, at least one report indicative of charging rate change information, discharging rate change information, movement information, or radio operational change information; and transmit the first information based on the charging rate change information, the discharging rate change information, the movement information, or the radio operational change information.

Aspect 20 is the first network entity of any of aspects 1-19, where the first metric is one of a reference signal received power (RSRP), a received signal strength indicator (RSSI), or signal to noise and interference ratio (SINR).

Aspect 21 is a first network entity for wireless communication, including: a memory; and at least one processor coupled to the memory, where the at least one processor is configured to: receive, from a second network entity, a first information indicative of a first set of preferred resources for an energy transfer or a first set of non-preferred resources for the energy transfer, where the first set of preferred resources is associated with a first metric above a first threshold for energy harvesting, where the first set of non-preferred resources is associated with a second metric below the first threshold, where the first threshold is based on energy harvesting information associated with the first network entity, and where the first threshold is independent of a second threshold for data communication; and apply the first set of preferred resources for the energy harvesting or refrain from applying the first set of non-preferred resources for the energy harvesting.

Aspect 22 is the first network entity of aspect 21, where the at least one processor is configured to: receive, from the second network entity, second information indicative of a second set of preferred resources for the data communication or a second set of non-preferred resources for the data communication, where the second set of preferred resources for the data communication is associated with a third metric above the second threshold, and where the second set of non-preferred resources for the data communication is associated with a fourth metric below the second threshold.

Aspect 23 is the first network entity of any of aspects 21-22, where each of the first metric, the second metric, the third metric, or the fourth metric is one of a reference signal received power (RSRP), a received signal strength indicator (RSSI), or signal to noise and interference ratio (SINR).

Aspect 24 is the first network entity of any of aspects 21-23, where the energy harvesting information includes one or more of: information regarding at least one energy harvesting circuit associated with the first network entity, an efficiency associated with the first network entity, a band of charging or a frequency of charging associated with the first network entity, or a specified charging rate associated with the first network entity.

Aspect 25 is the first network entity of any of aspects 21-24, where the first threshold is based on one or more of: at least one priority or at least one quality of service (QoS) associated with at least one transmission enabled by the energy transfer or the specified charging rate.

Aspect 26 is the first network entity of any of aspects 21-25, where the at least one processor is configured to: transmit, to the second network entity, the at least one priority or the at least one QoS associated with the at least one transmission.

Aspect 27 is the first network entity of any of aspects 21-26, where the at least one processor is configured to: transmit, via layer 1 (L1), layer 2 (L2), or layer 3 (L3) signaling, at least one report indicative of charging rate change information, discharging rate change information, movement information, or radio operational change information.

Aspect 28 is the first network entity of any of aspects 21-27, where the first metric is one of a reference signal received power (RSRP), a received signal strength indicator (RSSI), or signal to noise and interference ratio (SINR).

Aspect 29 is a method of wireless communication for implementing any of aspects 1 to 20.

Aspect 30 is an apparatus for wireless communication including means for implementing any of aspects 1 to 20.

Aspect 31 is a computer-readable medium (e.g., a non-transitory computer-readable medium) storing computer executable code, where the code when executed by a processor causes the processor to implement any of aspects 1 to 20.

Aspect 32 is a method of wireless communication for implementing any of aspects 21 to 28.

Aspect 33 is an apparatus for wireless communication including means for implementing any of aspects 21 to 28.

Aspect 34 is a computer-readable medium (e.g., a non-transitory computer-readable medium) storing computer executable code, where the code when executed by a processor causes the processor to implement any of aspects 21 to 28.

1. A first network entity for wireless communication, comprising:
a memory; and
at least one processor coupled to the memory, wherein the at least one processor is configured to:
receive energy harvesting information associated with at least one second network entity; and
transmit, for the at least one second network entity, first information indicative of a first set of preferred resources for an energy transfer or a first set of non-preferred resources for the energy transfer, wherein the first set of preferred resources is associated with a first metric above a first threshold for energy harvesting, wherein the first set of non-preferred resources is associated with a second metric below the first threshold, wherein the first threshold is based on the energy harvesting information, and wherein the first threshold is independent of a second threshold for data communication.

2. The first network entity of claim 1, wherein the at least one processor is configured to:
determine the first threshold based on the energy harvesting information.

3. The first network entity of claim 1, wherein the at least one processor is configured to:
determine, for the at least one second network entity, a second set of preferred resources for the data communication or a second set of non-preferred resources for the data communication, wherein the second set of preferred resources for the data communication is associated with a third metric above the second threshold, and wherein the second set of non-preferred resources for the data communication is associated with a fourth metric below the second threshold.

4. The first network entity of claim 3, wherein each of the first metric, the second metric, the third metric, or the fourth metric is one of a reference signal received power (RSRP), a received signal strength indicator (RSSI), or signal to noise and interference ratio (SINR).

5. The first network entity of claim 3, wherein the at least one processor is configured to:
determine the first set of preferred resources for the energy transfer and the first set of non-preferred resources for the energy transfer based on the second set of preferred resources for the data communication or the second set of non-preferred resources for the data communication.

6. The first network entity of claim 3, wherein, to determine the second set of preferred resources for the data communication or the second set of non-preferred resources for the data communication, the at least one processor is configured to:
determine the second set of preferred resources for the data communication or the second set of non-preferred resources for the data communication based on the first set of preferred resources for the energy transfer and the first set of non-preferred resources for the energy transfer.

7. The first network entity of claim 3, wherein the at least one processor is configured to:
transmit, for the at least one second network entity, second information indicative of the second set of preferred resources for the data communication or the second set of non-preferred resources for the data communication.

8. The first network entity of claim 7, wherein, to transmit the second information, the at least one processor is configured to:
transmit the second information to the at least one second network entity or a third network entity, wherein the at least one second network entity is at least one energy harvesting network entity and the third network entity is a non-energy harvesting network entity.

9. The first network entity of claim 7, wherein the at least one second network entity corresponds to a single network entity, and wherein, to transmit the first information and the second information, the at least one processor is configured to:
multiplex, at a bit level or a resource element (RE) level, the first information and the second information, wherein the first information is indicative of the first set of preferred resources for the energy transfer, and where the second information is indicative of the second set of preferred resources for the data communication.

10. The first network entity of claim 7, wherein the at least one second network entity corresponds to a single network entity, and wherein the at least one processor is configured to:
multiplex, at a bit level or a resource element (RE) level, the first information and the second information, wherein the first information is indicative of the first set of non-preferred resources for the energy transfer, and wherein the second information is indicative of the second set of preferred resources for the data communication.

11. The first network entity of claim 7, wherein the at least one second network entity corresponds to a single network entity, and wherein the at least one processor is configured to:
multiplex, at a bit level or a resource element (RE) level, the first information and the second information, wherein the first information is indicative of the first set of preferred resources for the energy transfer, and wherein the second information is indicative of the second set of non-preferred resources for the data communication.

12. The first network entity of claim 7, wherein the at least one second network entity corresponds to a single network entity, and wherein the at least one processor is configured to:
multiplex, at a bit level or a resource element (RE) level, the first information and the second information, wherein the first information is indicative of the first set of non-preferred resources for the energy transfer, and wherein the second information is indicative of the second set of non-preferred resources for the data communication.

13. The first network entity of claim 1, wherein, to transmit the first information, the at least one processor is configured to:
transmit the first information to the at least one second network entity or a third network entity, wherein the at least one second network entity is at least one energy harvesting network entity and the third network entity is a non-energy harvesting network entity.

14. The first network entity of claim 1, wherein the energy harvesting information comprises one or more of:
information regarding at least one energy harvesting circuit associated with the at least one second network entity,
at least one efficiency associated with the at least one second network entity,
at least one band of charging or at least one frequency of charging associated with the at least one second network entity, or
at least one specified charging rate associated with the at least one second network entity.

15. The first network entity of claim 14, wherein the first threshold is based on one or more of: at least one priority or at least one quality of service (QoS) associated with at least one transmission enabled by the energy transfer or the at least one specified charging rate.

16. The first network entity of claim 15, wherein the at least one processor is configured to:
receive, via signaling from the at least one second network entity or a separate sidelink control information (SCI), the at least one priority or the at least one QoS associated with the at least one transmission.

17. The first network entity of claim 1, wherein the second threshold is based on one or more of: at least one priority or at least one quality of service (QoS) associated with the data communication.

18. The first network entity of claim 1, wherein, to transmit the first information, the at least one processor is configured to transmit the first information based on a request via layer 1 (L1), layer 2 (L2), or layer 3 (L3) signaling.

19. The first network entity of claim 1, wherein the at least one processor is configured to:
receive, via layer 1 (L1), layer 2 (L2), or layer 3 (L3) signaling, at least one report indicative of charging rate change information, discharging rate change information, movement information, or radio operational change information; and
transmit the first information based on the charging rate change information, the discharging rate change information, the movement information, or the radio operational change information.

20. The first network entity of claim 1, wherein the first metric is one of a reference signal received power (RSRP), a received signal strength indicator (RSSI), or signal to noise and interference ratio (SINR).

21-30. (canceled)
